(19) United States
(12) Patent Application Publication
(10) Pub. No.: US 2008/0210701 A1
(43) Pub. Date: Sep. 4, 2008

(54) Medicinal Organizer

(76) Inventor: Martin R. Cooper, Cincinnati, OH (US)

Correspondence Address: ULMER & BERNE, LLP;ATTN: DIANE BELL, 600 VINE STREET, SUITE 2800, CINCINNATI, OH, 45202-2409, US

(21) Appl. No.: 12/041,528

(22) Filed: Mar. 3, 2008

Related U.S. Application Data
(60) Provisional application No. 60/904,475, filed on Mar. 2, 2007.
(60) Provisional application No. 61/010,166, filed on Jan. 4, 2008.

(51) Int. Cl. G07F 11/00; B65D 83/04; G06F 17/00

(52) U.S. Cl. 221/3; 206/538; 221/1; 700/231

(57) ABSTRACT

A medicinal organizer having a base and a plurality of containers. The base includes an alert system and a hanging arrangement. The plurality of containers is configured to be placed on the hanging arrangement. Each container is configured with at least one access opening disposed on a bottom section of each container allowing for the retrieval of medicinal item held within each respective container. Methods of using a medicinal organizer are also provided.

### REFERENCE TO RELATED APPLICATIONS

The present application claims priority of U.S. Provisional Application Ser. No. 60/904,475, filed Mar. 2, 2007, and U.S. Provisional Application Ser. No. 61/010,166, filed Jan. 4, 2008, the entire disclosures of which are hereby incorporated herein by reference.

### TECHNICAL FIELD

Systems and methods are provided for organizing pills for a recipient and alerting the recipient as to when the pills should be taken.

### BACKGROUND

Conventional medicinal organizers or “pill organizers” help organize and inform recipients when to take their dosage of medicines. Many such designs label packages or containers with the information regarding the contents contained along with the associated date and time in which the medicines are to be taken.

While conventional medicinal organizers provide some ability to aid the user in taking pills, and caregivers in monitoring compliance, such organizers are often difficult to use, subject to inaccuracy and/or expensive to manufacture.

### SUMMARY

In accordance with one embodiment, a flexible container comprises multiple compartments configured to hold medicinal items for a dosage and a notification section configured to inform a recipient what date the medicinal items are to be administered.

In accordance with another embodiment, a system for organizing medicinal items and alerting recipients when to take a designated medicinal item comprises a base and a plurality of containers. The base includes an alert system and a hanging arrangement. The plurality of containers is configured to be placed on the hanging arrangement. Each container is configured with at least one access opening disposed on a bottom portion of each container allowing for the retrieval of medicinal item held within each respective container.

In accordance with yet another embodiment, a method for alerting a recipient when to take a medicinal item comprises providing a system having a base and hanging containers, wherein the hanging containers are configured to hold medicinal items and the base comprises a clock. The method further comprises alerting a recipient when a dosage of medicinal items should be taken by providing a unique identifier on each container which matches a unique identifier on the clock.

In accordance with still another embodiment, a system for organizing medicinal items and alerting recipients when to take the designated medicinal items comprises a base and a plurality of containers. The base includes an alert system, a hanging arrangement and a reader device. The plurality-of-containers is configured to be placed on the hanging arrangement. The containers comprise at least one access opening and at least one electronic chip. The at least one access opening is configured to hold a medicinal item and the at least one electronic chip is configured to store predetermined information associated with the medicinal item.

In accordance with another embodiment, a method for alerting a recipient when to take a dosage of medicine comprises providing a visual notification to a recipient by aligning a unique identifier on a container with a unique identifier on a clock and providing an audio notification to a recipient when the unique identifier on the container matches the unique identifier on the clock.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1A illustrates a flexible container having a plurality of compartments;

FIG. 1B depicts the embodiment of FIG. 1A having the notification section disposed within one of the plurality of compartments;

FIG. 2 is a perspective view depicting an embodiment of a base configured to hold containers;

FIG. 3 is a perspective view depicting an embodiment of a system having flexible containers and a base which is configured to inform a recipient when to take desired medicines.

FIG. 4 is a perspective view depicting an embodiment of a system having flexible containers and a base with a reader device configured to inform a recipient when to take desired medicines;

FIG. 5A is a perspective view depicting a flexible container having a plurality of compartments, wherein the compartments can include a removable layer;

FIG. 5B is a front plan view depicting the flexible container of FIG. 5A;

FIG. 5C is a side plan view depicting the flexible container of FIG. 5A; and

FIG. 6 illustrates another embodiment of a medicinal organizer having a base and cartridges containing medicinal items.

### DETAILED DESCRIPTION

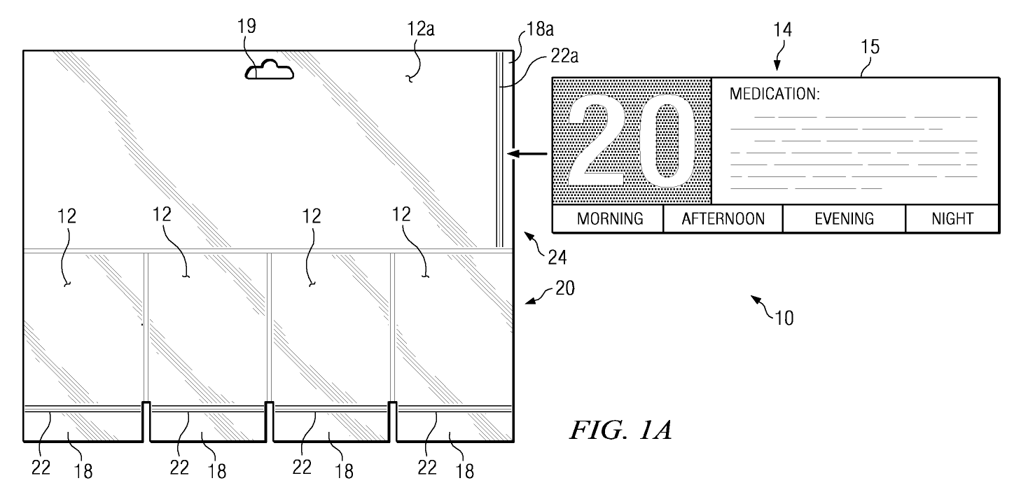

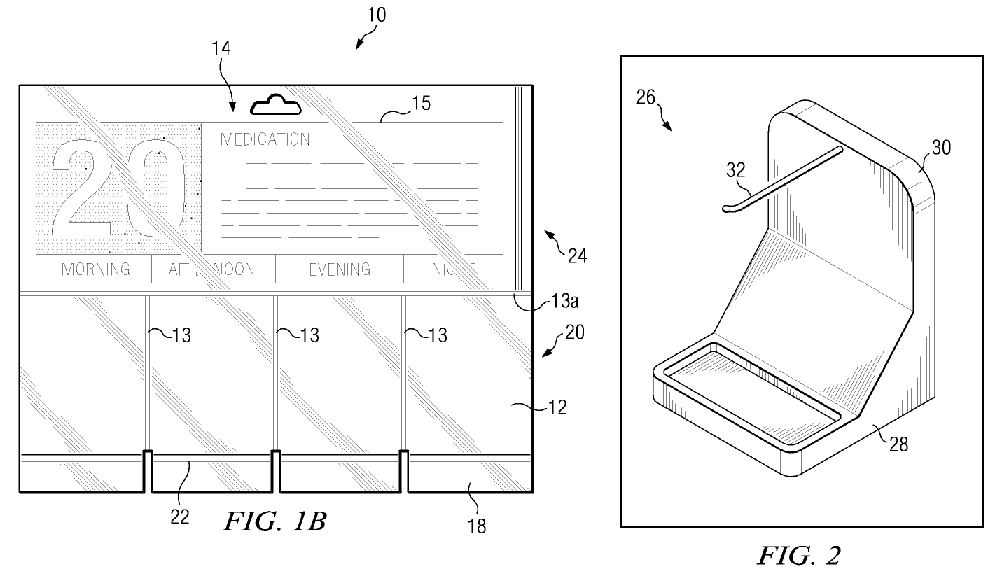

Embodiments are herein described in detail in connection with the drawings of FIGS. 1-6, wherein like numbers indicate the same or corresponding elements throughout the drawings.

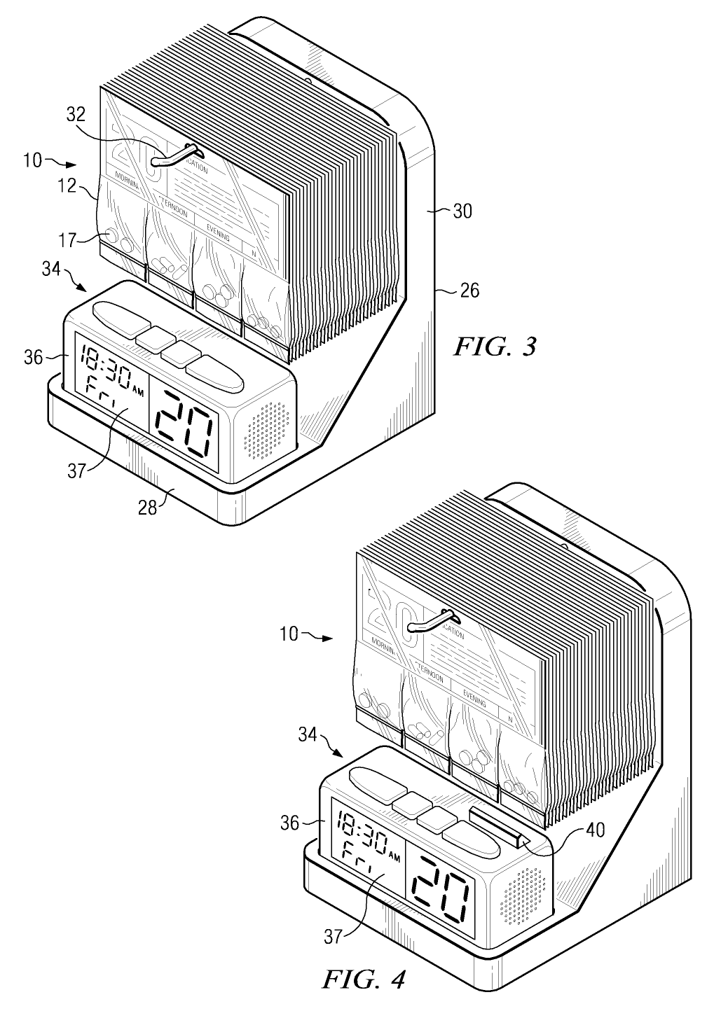

As illustrated in the embodiment of FIGS. 1A and 1B, a container 10 made of a flexible material can have at least one compartment 12 configured to store items (e.g., tags 15 and pills 17 (see FIG. 3)). The flexible material can include plastic materials such as polyvinyl films (i.e., PVC and PVA). In one embodiment, the flexible container 10 can have multiple compartments 12 or pockets, each being separated by walls 13 or by sealed material, as seen in FIGS. 1A and 1B. As further illustrated in FIGS. 1A, 1B and 3, one compartment 12a can be configured to hold a notification section 14 (e.g., tags 15) while other compartments 12 can be configured to hold medicinal-items (e.g., pills 17). In some embodiments, the compartments 12 can be configured to hold more than one medicinal item. In one embodiment, each of the compartments 12 or 12a can be configured to have an access opening, 18 or 18a from which the contents of the compartments 12 or 12a can be accessed. These access openings 18 or 18a can generally be placed along any portion of the compartment 12 or 12a. As further shown in the embodiments of FIGS. 1A, 1B and 3, the access openings 18 can be placed along a bottom section 20 of each of the compartments 12. The access openings 18 or 18a can also be configured to have a seal 22 or 22a which is resealable, for example, as shown in FIGS. 1A and 1B where a zip-scal arrangement is utilized. As such, the compartments 12 containing the pills 17 can be initially filled or refilled by the recipient, the recipient's caregiver, a pharmacist or even by the manufacturer of the container 10.

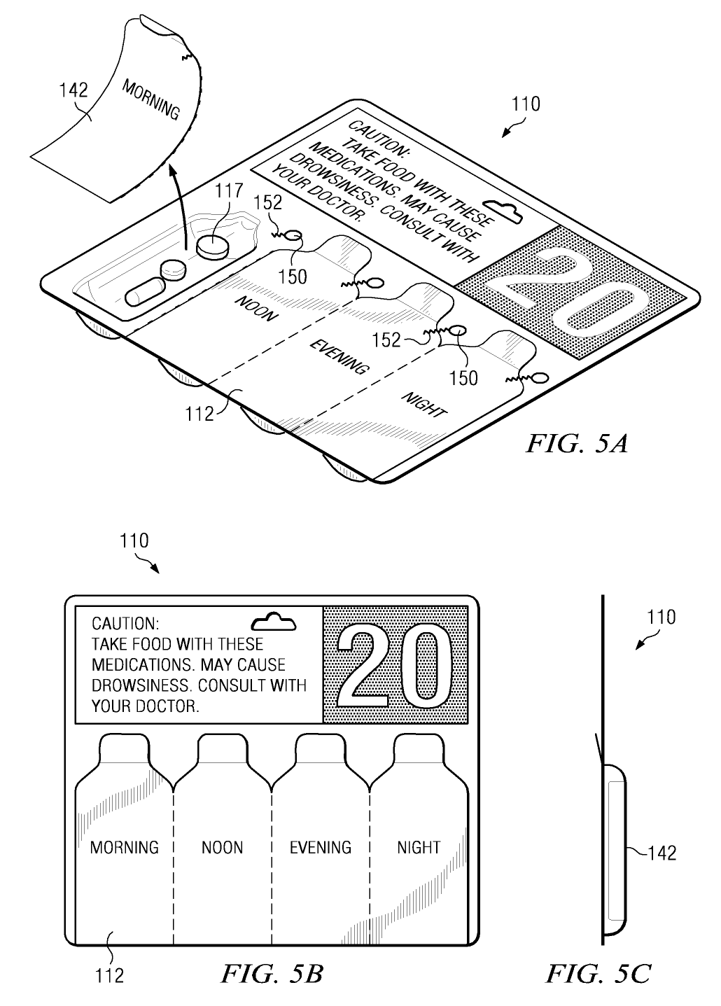

To form separate compartments 12 or 12a within the flexible-container 110, walls 13 or 13a can be included forming divisions between the compartments 12 or 12a within the flexible container 10, thus forming the individual compartments 12 or 12a as shown in FIGS. 1A and 1B. In another embodiment, the compartments can also be separated by die cuts (similar to the type of die cuts illustrated in the embodiment illustrated in FIG. 5A) formed along paths in between each of the individual compartments. The die cuts can form perforations in the flexible container, thereby allowing a recipient to remove the individual compartments from the flexible container. The compartments 12 containing the medicinal items, as, illustrated in FIG. 1B align with the notification section 14 that is provided in a corresponding compartment 12 of the flexible container 10 such that each of the compartments 12 containing medicinal items provides visual notification to the recipient when to take the pills contained within each of the respective compartments 12. As seen in FIG. 1B, for example, there are four compartments 12, each of which is associated with indicia to represent one of either the morning, afternoon, evening or night as provided by the notification section 14 associated with the flexible container 10.

As depicted in FIGS. 1A, 1B and 2, the flexible container 10 can have an upper opening 19 at an upper section 24 of the flexible container 10 such that it can be held by a base 26. The base 26 can include a bottom portion 28 and an upper portion 30, wherein the upper portion 30 has a member 32 on which to hang the flexible containers 10. This can be, more clearly seen in the embodiment of FIG. 3. As shown in FIG. 3, a plurality of flexible containers 10, can be hung on the member 32 (e.g., hanging arrangement) which extends outwardly from the upper portion 30 of the base 26. By placing the flexible containers 10 on the member 32 to be hung, the medicinal items can be easily retrieved by simply opening an access opening 18 and allowing the pills 17 to fall out of the flexible container 10. As shown in FIG. 3, the plurality of flexible containers 10 can constitute a monthly installment of pills for a recipient and can be replenished on a monthly basis. The base 26 can also include an alert system 34 as shown in the embodiment of FIG. 3. The alert system 34 can include a clock 36 having an alarm. The alert system 34 can also include other items as well, such as a calendar. The alert system 34 can inform a recipient when certain medicinal items are to be taken. The alert system 34 can accomplish this by sounding the alarm, thereby informing the recipient that designated medicinal items should be taken.

As one can see by the arrangement in the embodiment of FIG. 3, when the face 37 of the clock 36 matches up with the notification section (14 in FIG. 1B) associated with a particular compartment 12 of the flexible container 10, this provides a visual notification that the pills contained within that particular compartment 12 of the flexible container 10 are to: be taken. The alarm can provide an audio notification to a recipient informing him or her when it is time for their pills to be taken. For example, this audio notification can come by way of a loud piercing sound or a computer-generated voice informing the recipient that it is time to take his or her pills. It can be appreciated by one skilled in the art that the audio notification could comprise many forms.

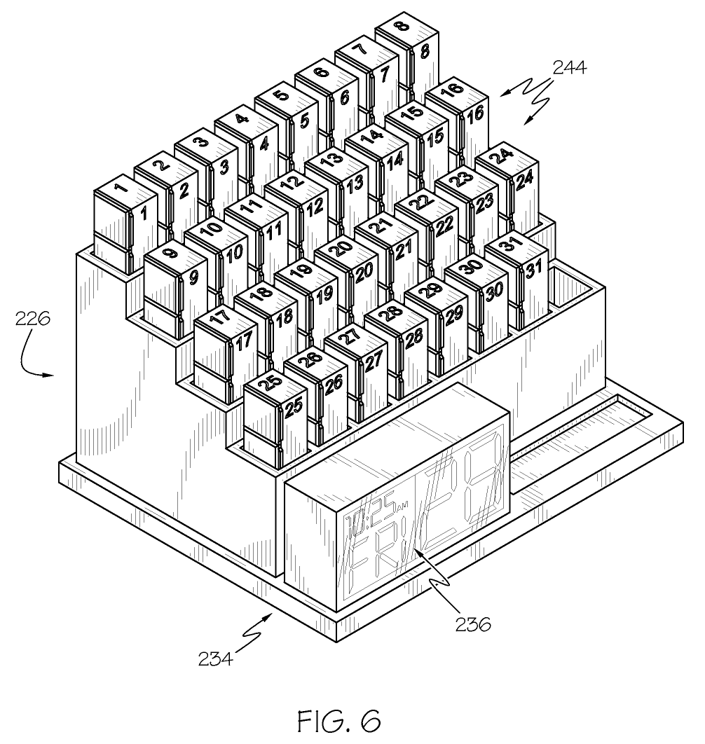

The combination of providing both a visual and audio sensory notification system to the recipient can be achieved by having a notification section 14 associated with the container 10 and an alert system 34 associated with the base 26 as shown in FIG. 3. For example, this dual sensory system informs the recipient that their pills are to be taken when the date on the clock or calendar matches up with the notification section associated with the flexible container by also setting off an alarm which further informs the recipient of the date and time. Another arrangement is further illustrated in FIG. 6. The arrangement of FIG. 6 includes a base 226 and a plurality of cartridges 244. The base 226 can include an alert system 234 (e.g., a clock 236). Again, in this design the alert system 234 can provide an alarm when the number on the clock 236 matches the number found on the respective cartridge 244. Other arrangements utilizing this dual sensory system could also be contemplated, such as that embodied in U.S. Patent No. D547,052, the entire disclosure of which is hereby incorporated by reference herein.

In regard to informing and alerting a recipient as to when he or she should take his or her designated medicinal items, another embodiment contemplates utilizing electronic components such as RFID (radio frequency identification) technology. For example, each individual containers 110 can include an electronic chip, such as an RFID chip (which can be more clearly seen in FIG. 5A as item 150) placed within the container 110 which provides a signal to the base 26 which can be picked up by a reader device (e.g., scanner 40 as shown in FIG. 4) located on or near the base 26 which in turn informs the alert system 34 that it is time for the recipient to take the designated medicinal items so that an alarm can be sounded. Such a system is illustrated in FIG. 4. In another embodiment, the reader device could also be configured to read bar coded containers as opposed to simply those containers that have RFID chip technology informing the alert system in a similar manner as to the date and time that the designated medicinal items are to be taken.

With RFID technology, the RFID chip sends a unique signal to the base indicating what type of pill is provided within the package and/or when the pill should be taken. The base can receive the signal and monitor compliance by the user. A software or firmware program in the base can monitor compliance by recognizing when a pill has been taken (e.g., if the package is moved away from the base or if the RFID chip and/or antenna is destroyed by opening the package, the signal ceases transmission to the base and the base thereby recognizes that the pill has been taken. If the base still receives the signal regarding that pill past the time that the pill was supposed to be taken by the recipient, the base will alert the user or caregiver by audio, visual or other signal, remotely (i.e., via wired or wireless data or phone transmission) and/or, locally (i.e., via alarm). It can be appreciated by one skilled in the art that such remote or local alerts can take many forms.

Moreover, the base can apply a general algorithm in determining what action to take. Once a signal is received, from the RFID chip, the base can check to see if the unique information provided by that RFID chip has expired, and if not, the base will recognize that it is not yet time for an alert to be broadcast because the pills do not yet have to be taken. If the time has expired, then the base will notify the alert system and provide the proper broadcast indicating to the user that it is time for the designated pills to be taken.

FIGS. 5A-5C illustrate an embodiment for a flexible container 110 (similar to a bubble pack arrangement) which could also include at least one electronic chip, such as a RFID chip 150. As illustrated in the embodiment of FIGS. 5A-5C, each individual compartment (e.g., 112) can further have a removable layer 142 which allows the recipient to easily access the medicinal items contained within the individual compartments 112. The individual compartments 112 can be designated in such a manner that visually informs the recipient when (i.e., what date and time) the designated pills 117 should be taken. In using RFID technology, an advantage in the embodiment of FIGS. 5A-5C can be that once the removable layer 142 has been stripped away from the flexible container 110, the RFID chip 150 will be: destroyed because an antenna 152 attached to the RFID chip 150 can be severed, thus preventing an alarm from sounding that those pills 117 have not been taken by the recipient.

RFID chips can be associated with a container in a variety of ways. In one embodiment, there could be a single RFID chip associated with each container providing designated information associated with that container. However, in another embodiment, it is contemplated that each compartment associated with the container could have its own RFID chip (as can be seen in the embodiment of FIG. 5A). That way, the particular designated information associated with the specific date and time for specific medicinal items held in each respective compartment could be tracked and maintained providing greater awareness for the recipient Once the medicinal items are taken, the RFID chips can be destroyed in a number of manners as well. One option includes opening of the container, which can destroy that antenna associated with the RFID chip, thereby rendering the RFID chip useless so that it would no longer provide a signal to the alert system to provide an alarm when the designated pill(s) needs to be taken. Another option would be to have the compartments individually removed from the container (as discussed above), this way, once the RFID chip is removed a certain distance from a reader device, the alert system will no longer sound an alarm. When the RFID chip is destroyed, or its antenna broken by opening the package, the base can recognize that a medicinal item has been taken by the user and can thereby monitor when pills have been taken. If a pill has not been taken at its designated time, the base can sound an alarm to the user and/or the caregiver.

Other advantages to using, systems and methods as described herein can be more, broadly contemplated as well. Many recipients need to be reminded or alerted to take their pills for numerous reasons and because of some circumstances (i.e., a recipient perhaps falls or is injured) other alert options are also possible. For example, the system illustrated in FIG. 4 could be connected to the internet via a computer, telephone, wireless phone, etc. such that when the alarm is sounded a message is sent to the caregiver of the recipient. Such a message could be sent by way of email or other electronic format informing the caregiver that the alarm has been sounded, that the designated pills have not been taken, that way the caregiver can stop by to check and see why the designated medicine has not been taken by the recipient. Other advantages of such a system could include providing a wrist band (e.g., a watch) or a jewelry piece that the recipient could wear, so that when the alarm system is sounded, a RFID chip in the watch could detect the signal and set off alarm on the watch, thus informing the recipient that the alarm system is sounding and its time to retrieve their medicines for the day. The RFID chip could also contain a recipient's specific information, including a unique customer identifier, prescription drug information, doctor information, pharmacy filling information, drug interaction information, and drug labeling information.

The embodiment of the system illustrated in FIG. 4 could also be configured in such a manner so that the system could be stored easily in, for example, an armoire, a drawer or a cabinet so that it could be placed in an area out of the Way of the recipient if need be. Also, in another embodiment, the system could be designed as a portable device so that it could be taken on trips. In such an embodiment, the base could be a collapsible allowing it to be folded upon itself and easily placed within a travel bag or other carry-on luggage.

As can be understood, the functionality of the base and the other functionalities described herein can be implemented using software, firmware and/or associated hardware for carrying out the desired tasks. For instance, the various functionalities described can be programmed as a series of instructions, code, files, or commands using general purpose or special purpose, programming languages or programs, and can be executed on one or more general purpose or special purpose computers, processors, other control circuitry or networks.

Moreover, a central computer could be used to communicate with the RFID chips through the internet or other means of communication to not only provide notification to the recipient or the caregiver for dosing and control of the medicines, but could be used to provide control over the specific-medicinal items themselves as well as inventory control, such as the loading and filling of prescriptions at a pharmacy (or other drug, supplier, or packaging company). For example, the system could provide communication to a central computer stationed at a pharmacy which is directly informed to refill a prescription for a recipient when the supply of any medicinal item has been completely used. This way containers can be filled and shipped to the recipient without the recipient ever having to actively place or pickup their new or renewed prescriptions.

The foregoing description of embodiments and examples has been presented for purpose of illustration and description. It is not intended to be exhaustive or to limit the invention to the forms described. Numerous modifications are possible in light of the above teachings. Some of those modifications have been discussed, and others will be understood skilled in the art. The embodiments were chosen and described in order to best illustrate various embodiments as are suited to the particular use contemplated. It is hereby intended that the scope of the invention be defined by the claims appended hereto.

What is claimed is:

1. A flexible container comprising:
multiple compartments configured to hold medicinal items for a dosage; and
a notification section configured to inform a recipient what date the medicinal items are to be administered.

2. The flexible container according to claim 1, wherein each of the multiple compartments has at least one access opening.

3. The flexible container according to claim 1, wherein the multiple compartments are separated from one another within the container by die cuts.

4. The flexible container according, to claim 1, wherein the notification section comprises multiple identifiers.

5. The flexible container according to claim 4, wherein each of the multiple identifiers indicates at least one of a specific date, time, time of day and contents.

6. The flexible container according to claim 1, wherein each compartment is configured to hold more than one medicinal item.

7. A system for organizing medicinal items and alerting recipients when to take a designated medicinal item, the system comprises:
a base comprising an alert system and a hanging arrangement; and
a plurality of containers configured to be placed on the hanging arrangement, wherein each container is configured, with at least one access opening disposed on a bottom portion of each container allowing for the retrieval of medicinal item held within each respective container.

8. The system according to claim 7, wherein the alert system-comprises a clock.

9. The system according to claim 7, wherein the alert system comprises a calendar.

10. The system according to claim 7, wherein the alert system is configured to produce an audio signal informing a recipient when to take the designated medicinal item.

11. The system according to claim 7, wherein each of the plurality of containers comprises multiple compartments.

12. A method for alerting a recipient when to take a medicinal item, the method comprises:
providing a system having a base and hanging-containers, wherein the hanging containers are configured to hold medicinal items and the base comprises-a clock; and
alerting a recipient when a dosage of medicinal items should be taken by providing a unique identifier on each container which matches a unique identifier on the clock.

13. The method according to claim 12, wherein the unique identifier on the container which matches a unique identifier on the clock has the same date or number.

14. A system for organizing medicinal items and alerting recipients when to take the designated medicinal items, the system comprises:
a base comprising an alert system, a hanging arrangement and a reader device; and
a plurality of containers configured to be placed on the hanging arrangement, wherein the containers comprise at least one access opening and at least one electronic chip, wherein the at least one access opening is configured to hold a medical item and the at least one electronic chip is configured to store predetermined information associated with the medicinal item.

15. The system according to claim 14, wherein the at least one electronic chip is embedded into each of the containers.

16. The system according to claim 14, wherein the predetermined information is the date and time in which the medicinal item is to be used.

17. The system according to claim 14, wherein each of the containers further comprise an antenna line.

18. The system according to claim 14, wherein the predetermined information comprises the type of medicinal item stored in each of the containers.

19. The system according to claim 14, wherein the alert system comprises a clock.

20. The system according to claim 14, wherein the reader device-comprises a scanner configured to read the predetermined information on the at least one electronic chip on each of the plurality of containers.

21. The system according to claim 14, wherein the at least one electronic chip comprises an RFID chip.

22. The system according to claim 14, wherein the at least one electronic chip contains recipient's information, including a unique customer identifier, prescription drug information, doctor information, pharmacy filling information, drug interaction information, and drug labeling information.

23. A method for alerting a recipient when to take a dosage of medicine, the method comprising:
providing a visual notification to a recipient by aligning a-unique identifier on a container with a unique identifier on a clock; and
providing an audio notification to a recipient when the unique identifier on the container matches the unique identifier on the clock.
